(19) United States
(12) Patent Application Publication
(10) Pub. No.: US 2022/0237694 A1
(43) Pub. Date: Jul. 28, 2022

(54) Price Superhighway

(71) Applicant: Saeed Hassan, Bangkok (TH)

(72) Inventor: Saeed Hassan, Bangkok (TH)

(21) Appl. No.: 17/159,002

(22) Filed: Jan. 26, 2021

(51) Int. Cl. G06Q 40/04; G06Q 30/02

(52) U.S. Cl. CPC G06Q 40/04; G06Q 30/0201; G06Q 30/0206

(57) ABSTRACT

The formulation of precise support and resistance levels on a candlestick chart based on a prescribed way to depict the cyclical behavior of price of any financial instrument. The support and resistance levels are based on repeating ranges within and across cycles, rather than averaged prices, trend lines or mathematical ratios. The resulting trading signals can be executed manually by a trader or used as input into a computerized trading system. The interaction of price at each support and resistance level gives rise to the aforementioned trading signals, and the different cycles form layers in a hierarchical system of support and resistance, where each layer in the hierarchy is denominated Price Superhighway, Floor, Building, or City.

### TECHNICAL FIELD

This application relates in general to a system and method for stock price analysis tools, and more specifically, to a system and method for creating a hierarchical system of trading signals in financial markets.

### BACKGROUND

Advancements in electronic trading during the last twenty years can be classified in two principal dimensions.

The first relates to methods that calculate entry and exit levels, often in the form of support and resistance levels, that govern or estimate the behavior of a financially traded instrument. Thus far, such methods are often based on trend lines or channels (whether on linear or logarithmic price scales), averaged price levels, mathematical ratios such as Fibonacci retracements or wave structures in price such as Elliot Wave. The cited prior artwork focuses on advancing these methods. The second dimension, often referred to as High Frequency Trading (HFT), is a type of algorithmic trading characterized by high speeds, high turnover rates, and high order-to-trade ratios that leverage high-frequency financial data processing. This form of trading is characterized by short holding periods, often fractions of a second, and large transactional volumes. Many trading algorithms are in fact simple arbitrages which could have previously been performed at lower frequency—and where competition over the years has occurred through who can execute faster rather than who can create new breakthrough strategies.

In line with ever increasing computational power, the greatest breakthroughs in electronic trading in the last twenty years have been through advances in the second dimension, namely speed and volume. This evolution has largely reduced trading success to those who have the greatest computational power, obviating the development of breakthrough strategies often associated with the first dimension. In fact, the majority of previous artworks in the field of trading have been filed close to and over ten years ago. By value, HFT was estimated by consultancy Tabb Group in 2010 to make up 56% of equity trades in the US and 38% in Europe. And as HFT strategies become more widely used, it has been more difficult to execute them profitably. According to estimates from Purdue University, profits from HFT in the US declined from an estimated peak of $5 billion in 2009 to about $1.25 billion in 2012. And, though the percentage of volume attributed to HFT in the equity markets has fallen, it has remained high in the futures markets. According to market studies, the percentage of volume attributed to HFT in the US futures markets increased from 25% of all volume in 2010, to more than 60% in 2012.

The invention subject to this patent addresses the void created by HFT, by looking again at price behavior. And in doing so, advance the field of trading itself, rather than see it as an application of computational superpower. In addition, it offers the opportunity to strengthen the trading strategies employed by HFT, to include elements based on the behavior of price, and go further than simple arbitrage opportunities exploited by the majority of firms today.

Identifying precise price support and resistance levels at each given moment in time is the foundation of technical trading in the financial markets, more specifically on the financial exchanges around the world where financial instruments are bought and sold.

Technical traders use support and resistance levels to determine how and when the price of a financial instrument may undergo a trend change or other tradable change in behavior. Examples of tradable changes in behavior include price reversing higher from a support level, price pulling back from a resistance level, breakouts across resistance levels, and breakdowns below supports. The resulting movement between price levels forms the basis of the trade where traders enter and exit positions held in the financial instrument. This basis is the same whether the trade is carried out by a trader directly, or by computer programs created to do so on behalf of the trader. And the basis is the same regardless of asset class or financial instrument being traded. Examples of financial instruments include, but are not limited to, currencies, stocks, bonds, commodities, exchange traded funds (ETFs), crypto assets, and futures contracts.

While price levels derived in this way may approximate levels that lead to initial breakouts and breakdowns, they often give false positives where breakouts and breakdowns are ultimately rejected due to other unforeseen support and resistance levels. What existing methods lack is that they do not take into account a higher order set of support and resistance governed by the cyclical nature of price, and it is this hierarchy of support and resistance levels, beyond what is often considered, that can lead to failed or missed trading signals.

Cycles play an important role in describing the price action of all financial instruments, in that they explain different layers, or a hierarchy, of support and resistance beyond traditional methods. An understanding of how price reacts inside and across cycles would offer a discernible advantage to a trader over methods currently understood and used today.

The price of a financial instrument may frequently undergo a more severe or rapid change in price (beyond a simple breakout or breakdown). Examples of more severe price movements include market corrections, crashes, and reversals from market tops. Methods that forecast when and how such events occur would help a trader or computerized trading system to better manage risk, as well as to be prepared to profit from the opportunity that these events represent.

Therefore, a need exists for creating a hierarchical system of trading signals in financial markets. The present invention attempts to address the limitations, deficiencies, and inefficiencies of existing solutions according to the principles and example embodiments disclosed herein.

### SUMMARY

In accordance with the present invention, the above and other problems are solved by providing a system and method for creating a hierarchical system of trading signals in financial markets according to the principles and example embodiments disclosed herein.

In one embodiment, the present invention is a system for creating a hierarchical system of trading signals in financial markets. The broker computing device is communicatively connected to one or more stock market computing devices over the Internet. The one or more stock market computing devices provide securities price data on securities available to initiate trades using the one or more stock market computing devices.

In another aspect of the present invention, the broker computing device includes a memory having instructions stored thereon, and a processor configured to execute the instructions on the memory to cause the broker computing device to obtain securities price data for a requested period of time, identify security price candlesticks for each of the specified trading periods within the requested period of time, define a building ellipse having an edge found within a maximum number of candlesticks within the request time period of candlestick data, define a set of parabolic curves, a first parabolic curve of the set of parabolic curves having a starting point identical to the ellipse starting location and a second parabolic curve within the set of parabolic curves being parallel to the first parabolic curve and located at a floor distance above the first parabolic curve such that the second parabolic curve possesses at least three data values within candlesticks in contact with the building ellipse, and each additional parabolic curves within the set of parabolic curves absent the first and second parabolic curves are located a floor distance above a prior parabolic curve within the set of parabolic curves until a highest parabolic curve is a last parabolic curve having a value within a highest candlestick within one or more candlesticks within the building ellipse, identify at least one ellipse having a time value beyond the time value of the latest candlestick in the requested time period, and identify top and bottom edges of the at least one building ellipse on the price chart having a time value beyond the time value of the latest candlestick in the requested time period as support and resistance values for the securities price data and a latest time value of the ellipse, the latest time value of the at least one building ellipse on the price chart defines an end of a price value cycle.

In another aspect of the present disclosure, the securities price data comprises an opening price, a closing price, a highest price, and a lowest price for a particular security during a specified trading time period. The candlesticks for each specified trading period comprise a range of securities price values between the highest price and the lowest price in each of the specified trading periods as plotted on a price chart. The building ellipse have an ellipse starting location on the price chart defined by the lowest price for the first candlestick used to define the building ellipse and the time value corresponding to the first candlestick used to define the building ellipse.

The invention describes a novel way to define price supports and resistances of any financial instrument listed on any financial market by describing how price moves in cycles and across clusters of cycles known as denominated super cycles.

The invention defines the process of constructing candlestick price charts which show precise two-dimensional spaces created using ellipses (denominated Buildings), that detail how price moves in cycles situated along parabolic paths (denominated Price Superhighway). The invention further details how clusters of Buildings form larger structures (denominated Cities), that detail how price moves in super cycles, thereby defining a hierarchy of support and resistance levels.

The invention addresses the drawbacks of existing technical trading methods, in part, by examining the price behavior as it crosses different layers in the hierarchy of support and resistance, thereby reducing the risk of failed trading signals. Additionally, the expected range of price movement itself, once a support or resistance level is breached, is more predictable using this invention. Determining expected price movement is a key consideration when deciding how and when to exit trades once support and resistance levels are crossed. The invention addresses expected price movements by looking at equal-height spaces between support and resistance levels, called Floors.

In another aspect of the present disclosure, the broker computing device obtains additional securities price data for a second requested period of time, identifies additional security price candlesticks for each of the specified trading periods within the second requested period of time, when the additional security price candlesticks have time values beyond the range of the building ellipse, the broker computing device defines a second building ellipse having an edge found having at least three candlesticks in which each of the at least three candle sticks highest price on the second ellipse, defines a second set of parabolic curves, a first parabolic curve of the second set of parabolic curves having a starting point identical to the second ellipse starting location and a second parabolic curve within the second set of parabolic curves being parallel to the first parabolic curve of the second set of parabolic curves, and located at a second floor distance above the first parabolic curve of the second set of parabolic curves such that the second parabolic curve of the second set of parabolic curves possesses at least three data values within additional candlesticks in contact with the second building ellipse, and each additional parabolic curves within the second set of parabolic curves absent the first and second parabolic curves are located the second floor distance above a prior parabolic curve within the second set of parabolic curves until a highest parabolic curve is a last parabolic curve having a value within a highest candlestick within one or more candlesticks within the second building ellipse, identify at least one building ellipse having a time value beyond the time value of the latest candlestick in the requested time period, and identifies top and bottom edges of the at least one second building ellipse on the price chart having a time value beyond the time value of the latest candlestick in the second requested time period as support and resistance values for the securities price data and a latest time value of the second building ellipse, the latest time value of the at least one second building ellipse on the price chart defines an end of a second price value cycle.

In yet another aspect of the present disclosure, the broker computing device defines a city ellipse having an edge found having at least three candlesticks in which each of the at least three candlesticks highest price on the second ellipse, defines a set of city parabolic curves, a first city parabolic curve of the set of city parabolic curves having a starting point identical to the city ellipse starting location and a city parabolic curve within the set of city parabolic curves being parallel to the first city parabolic curve of the set of city parabolic curves, and located at a city floor distance above the first city parabolic curve of the set of city parabolic curves such that the second city parabolic curve of the set of city parabolic curves possesses at least three data values within additional candlesticks in contact with the city ellipse, and each additional city parabolic curves within the set of city parabolic curves absent the first and second city parabolic curves are located the city floor distance above a prior city parabolic curve within the set of city parabolic curves until a highest city parabolic curve is a last city parabolic curve having a value within a highest candlestick within one or more candlesticks within the city ellipse, identifies at least one city ellipse having a time value beyond the time value of the latest candlestick in the additional requested time period, and identifies top and bottom edges of the at least one city ellipse on the price chart having a time value beyond the time value of the latest candlestick in the additional requested time period as support and resistance values for the securities price data and a latest time value of the second ellipse, the latest time value of the at least one second ellipse on the price chart defines an end of a city price value cycle.

In another aspect of the present disclosure, the broker computing device further includes a local data storage device, and. a database engine for storing, organizing, searching, and displaying securities price data, candlestick data, building ellipse data, sets of parabolic curves data, city ellipse data, and sets of city parabolic ellipse data.

In another aspect of the present disclosure, the broker computing device further includes a user interface configured to present the price chart and its corresponding securities price data, candlestick data, building ellipse data, sets of parabolic curves data, city ellipse data, and sets of city parabolic ellipse data.

In another embodiment, the present invention is a method for creating a hierarchical system of trading signals in financial markets. The method obtains additional securities price data for a second requested period of time, identifies additional security price candlesticks for each of the specified trading periods within the second requested period of time, when the additional security price candlesticks have time values beyond the range of the building ellipse, the broker computing device defines a second building ellipse having an edge found having at least three candlesticks in which each of the at least three candle sticks highest price on the second ellipse, defines a second set of parabolic curves, a first parabolic curve of the second set of parabolic curves having a starting point identical to the second ellipse starting location and a second parabolic curve within the second set of parabolic curves being parallel to the first parabolic curve of the second set of parabolic curves, and located at a second floor distance above the first parabolic curve of the second set of parabolic curves such that the second parabolic curve of the second set of parabolic curves possesses at least three data values within additional candlesticks in contact with the second building ellipse, and each additional parabolic curves within the second set of parabolic curves absent the first and second parabolic curves are located the second floor distance above a prior parabolic curve within the second set of parabolic curves until a highest parabolic curve is a last parabolic curve having a value within a highest candlestick within one or more candlesticks within the second building ellipse, identify at least one building ellipse having a time value beyond the time value of the latest candlestick in the requested time period, and identifies top and bottom edges of the at least one second building ellipse on the price chart having a time value beyond the time value of the latest candlestick in the second requested time period as support and resistance values for the securities price data and a latest time value of the second building ellipse, the latest time value of the at least one second building ellipse on the price chart defines an end of a second price value cycle.

In another aspect of the present disclosure, the method further obtains additional securities price data for a second requested period of time, identifies additional security price candlesticks for each of the specified trading periods within the second requested period of time, when the additional security price candlesticks have time values beyond the range of the building ellipse, the broker computing device defines a second building ellipse having an edge found having at least three candlesticks in which each of the at least three candle sticks highest price on the second ellipse, defines a second set of parabolic curves, a first parabolic curve of the second set of parabolic curves having a starting point identical to the second ellipse starting location and a second parabolic curve within the second set of parabolic curves being parallel to the first parabolic curve of the second set of parabolic curves, and located at a second floor distance above the first parabolic curve of the second set of parabolic curves such that the second parabolic curve of the second set of parabolic curves possesses at least three data values within additional candlesticks in contact with the second building ellipse, and each additional parabolic curves within the second set of parabolic curves absent the first and second parabolic curves are located the second floor distance above a prior parabolic curve within the second set of parabolic curves until a highest parabolic curve is a last parabolic curve having a value within a highest candlestick within one or more candlesticks within the second building ellipse, identify at least one building ellipse having a time value beyond the time value of the latest candlestick in the requested time period, and identifies top and bottom edges of the at least one second building ellipse on the price chart having a time value beyond the time value of the latest candlestick in the second requested time period as support and resistance values for the securities price data and a latest time value of the second building ellipse, the latest time value of the at least one second building ellipse on the price chart defines an end of a second price value cycle.

In yet another aspect of the present disclosure, the method defines a city ellipse having an edge found having at least three candlesticks in which each of the at least three candlesticks highest price on the second ellipse, defines a set of city parabolic curves, a first city parabolic curve of the set of city parabolic curves having a starting point identical to the city ellipse starting location and a city parabolic curve within the set of city parabolic curves being parallel to the first city parabolic curve of the set of city parabolic curves, and located at a city floor distance above the first city parabolic curve of the set of city parabolic curves such that the second city parabolic curve of the set of city parabolic curves possesses at least three data values within additional candlesticks in contact with the city ellipse, and each additional city parabolic curves within the set of city parabolic curves absent the first and second city parabolic curves are located the city floor distance above a prior city parabolic curve within the set of city parabolic curves until a highest city parabolic curve is a last city parabolic curve having a value within a highest candlestick within one or more candlesticks within the city ellipse, identifies at least one city ellipse having a time value beyond the time value of the latest candlestick in the additional requested time period, and identifies top and bottom edges of the at least one city ellipse on the price chart having a time value beyond the time value of the latest candlestick in the additional requested time period as support and resistance values for the securities price data and a latest time value of the second ellipse, the latest time value of the at least one second ellipse on the price chart defines an end of a city price value cycle.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for creating a hierarchical system of trading signals in financial markets according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 shows two candlesticks to represent the candlesticks normally shown on candlestick charts used by traders.

FIG. 4 is a screenshot of a public company price chart, listed on the New York Stock Exchange and taken from the public website investing.com. It shows monthly candles from 2014 to October 2020.

FIG. 5 is a screenshot of the same public company price chart showing placement of the first elliptical component of a Building.

FIG. 6 is a screenshot of the same public company price chart showing placement of the first parabolic curve component of the Price Superhighway.

FIG. 7 is a screenshot of the same public company price chart showing the complete Price Superhighway.

FIG. 8 is a screenshot of the same public company price chart showing a complete Building.

FIG. 9 is a screenshot of the same public company price chart showing the first elliptical component of a second Building.

FIG. 10 is a screenshot of the same public company price chart showing the second completed Building on the same Price Superhighway.

FIG. 11 is a screenshot of the same public company price chart showing the price support and resistance levels in the second building. It also shows the cycle duration governed by the second Building.

FIG. 12 is a screenshot of the same public company price chart showing the multiple instances where, either the open, close, high or low of a monthly candle coincides with levels predicted by support and resistance levels defined inside a Building.

FIG. 13 is a screenshot of the same public company price chart showing the multiple instances where, either the open, close, high or low of a monthly candle coincides with levels predicted by support and resistance levels defined on the Price Superhighway.

FIG. 14 is a screenshot of the same public company price chart showing placement of the first elliptical component of a City.

FIG. 15 is a screenshot of the same public company price chart showing a complete City.

FIG. 16 is a screenshot of the same public company price chart marking support and resistance levels defined by a Building together with support and resistance levels defined by the City.

FIG. 17 is a screenshot of the same public company price chart showing the multiple instances where, either the open, close, high or low of a monthly candle coincides with levels predicted by support and resistance levels defined by the City.

FIG. 18 illustrates a set of software components running on one or more computers to implement the calculation of support and resistance levels defined by the structures according to the present invention, namely the Floors, Buildings, Cities and Price Superhighway.

FIG. 19 illustrates a flowchart of a method for implementing the calculation of support and resistance levels defined by the structures according to the present invention.

### DETAILED DESCRIPTION

This application relates in general to a system and method for creating a stock price analysis tool, and more specifically, to a system and method for creating a hierarchical system of trading signals in financial markets according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

The term “the” is used numerous times throughout the disclosure of this patent as a definite article referring to one or more objects that relate to a particular embodiment(s) being described. No such use of “the” should be interpreted as limiting the scope of the invention to only the embodiment(s) being described unless specifically stated otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

The term “mobile application” refers to an application executing on a mobile device such as a smartphone, tablet, and/or web browser on any computing device.

The terms “trader” and “user” refer to an entity, e.g. a human, using the invention including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiber optic cable(s), and ethernet cable(s) or wireless connection(s) using any type of frequency/frequencies or radio wave(s). Some examples are included below in this application.

The term “invention” or “present invention” refers to the invention being applied for via the patent application with the title “System and Method for Creating a Hierarchical System of Trading Signals in Financial Markets.” Invention may be used interchangeably with price predictions.

The terms “communicate” or “communication” refer to any component(s) connecting with any other component(s) in any combination for the purpose of the connected components to communicate and/or transfer data to and from any components and/or control any settings.

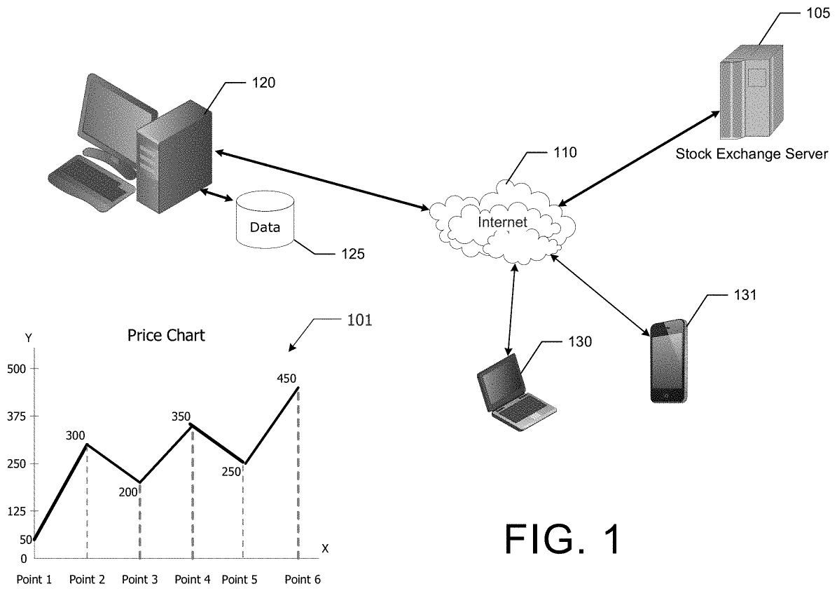

In general, the present disclosure relates to a system and method for creating a hierarchical system of trading signals in financial markets. To better understand the present invention, FIG. 1 illustrates a system for creating a hierarchical system of trading signals in financial markets according to the present invention. Stockbrokers, traders, and buyers/sellers of stock on various stock exchanges typically monitor one or more stock price fluctuations over time to predict when a particular stock may significantly change its value, both up or down, by estimating resistance and support levels for a current price from calculations of historical price fluctuations. This process also uses both the starting and ending prices for the stock over a stated time period as well as the high and low prices for the stock during the time period as part of these calculations.

Systems 100 that generate estimates for future price movement of a stock price utilize a broker computer 120 that obtains price data from a stock market computing system 115 over the Internet 110. Many stock market computing systems 115 provide price for stocks both as a summary of activity over defined time periods as well as slightly delayed prices of stock transactions during each trading period. The broker computer 120 may obtain this price data in many forms and this data is readily available to most brokers and traders from multiple sources on web pages accessible over the Internet 110.

The processing of all of this data to determine estimates of future price movements of any given stock sold on the stock exchanges requires a significant amount of processing resources including processing capacity, memory, database storage, and the like. Most processes that calculate these estimates 101 of future prices for the stocks do not have sufficient time and processing resources to perform many of the calculations needed for complex and sophisticated modeling approaches. Many brokers are able to make quite a good living from providing estimates from these estimating models as accurate estimates 101 are found to be valuable to buyers and sellers of the stocks analyzed by these estimating models. Brokers are always searching for a way to provide more accurate estimates for price movements while utilizing the available computational resources that consume and analyze the large amounts of historical price data maintained within a database 125 that is attached to the broker computing system 120.

The present invention discloses a system and method for calculating these estimates 101 from the price data in the database 125 that efficiently and accurately calculates these data values within the resources available within the broker computing system 120. The disclosed system and method 101 generates accurate price estimates without exceeding the limits of processing capabilities of these computing systems while providing fast and accurate data models for use by all interested parties.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC) or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

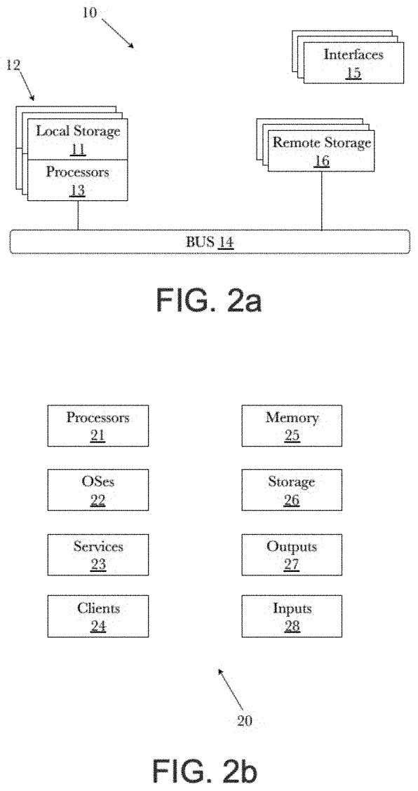

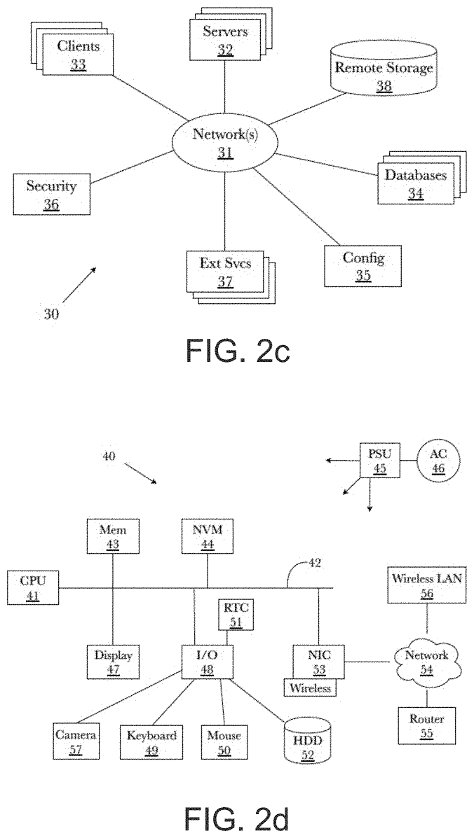

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPUs) 12, one or more interfaces 15, and one or more buses 14 (such as a peripheral component interconnect (PCI) bus). When acting under the control of appropriate software or firmware, a CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WIFI), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some respects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20 and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some respects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some respects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some respects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some respects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

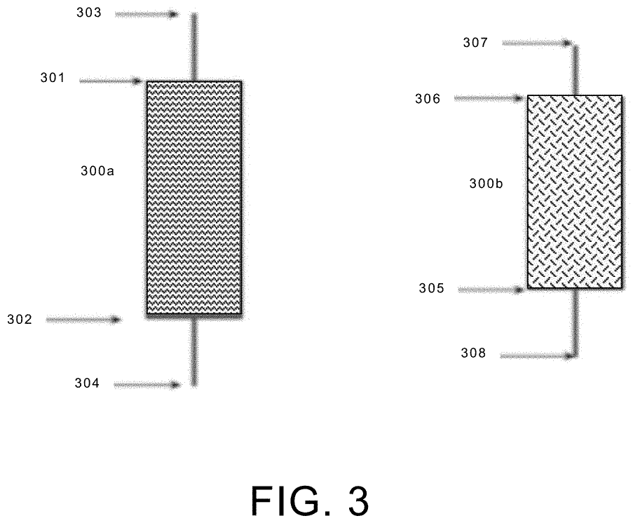

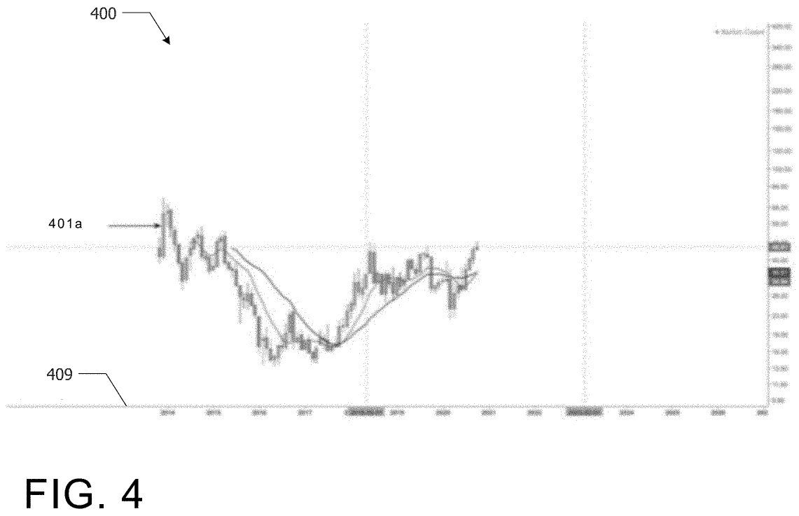

FIG. 3 shows two candlesticks to represent the candlesticks normally shown on candlestick charts used by traders. Technical traders use widely available candlestick charts to show how price moves during a fixed period of time. FIG. 3 shows two candlesticks 300a-b. The opening price 301, closing price 302, highest price 303 and lowest price 304 are indicated on the first candle 300a. The body of the candle is shaded using a first pattern or color, such as red, because the closing price is lower than the opening price. Levels marked on the second candle 300b show the opening price 305, closing price 306, highest price 307 and lowest price 308. Here, the body of the candle is shaded using a second pattern or color, such as green, because the closing price is higher than the opening price. FIG. 4, shows the candlestick chart 400 for Twitter Incorporated, where the timeframe of the chart is monthly, though the invention can be constructed for any and all timeframes. A monthly candlestick chart shows a trader the price movement during each month of time as one candlestick on the chart. Each candle 401 shows the opening price, the highest price during the month, the lowest price during the month, and the closing price at the end of the month. The scale used to show prices is logarithmic, though the invention covers charts created using both logarithmic and linear price scales.

FIG. 4 is a screenshot of the public company price chart 400, listed on the New York Stock Exchange and taken from the publicly available website investing.com. The price chart 400 shows monthly candles 401a-n from 2014 to October 2020. The starting point of the process to construct the invention is shown in FIG. 4.

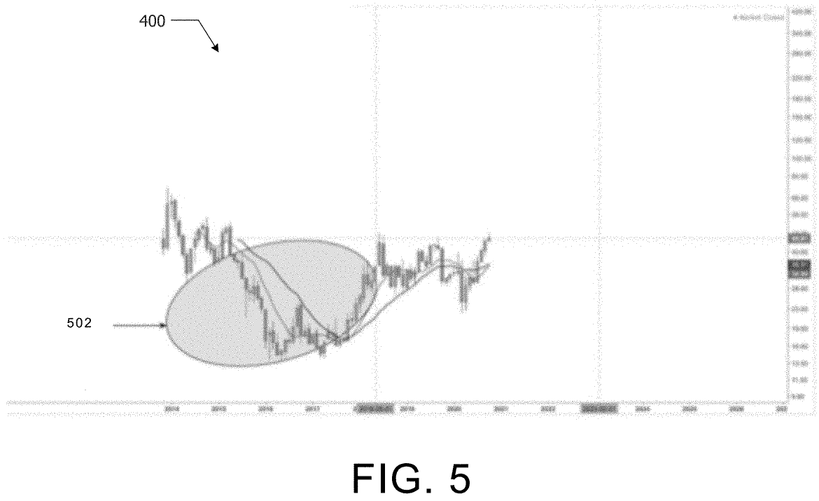

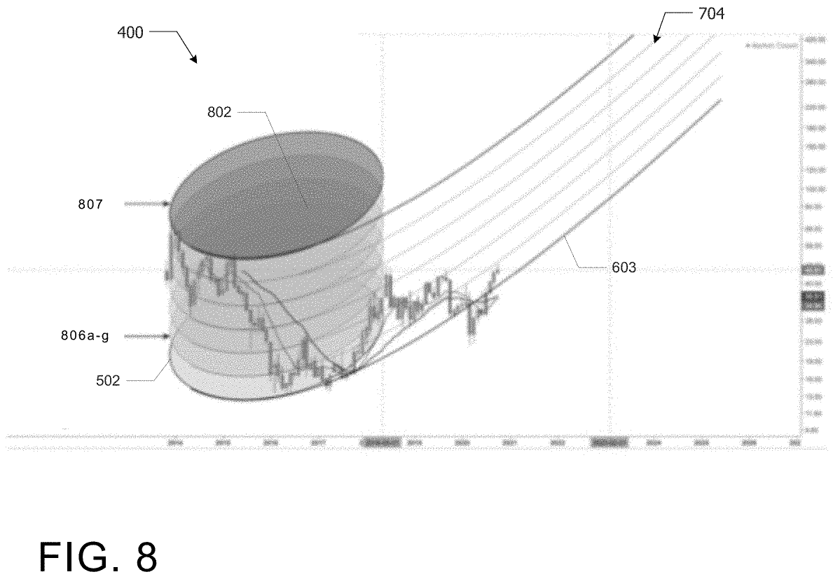

FIG. 5 is a screenshot of the same public company price chart 400 showing placement of the first elliptical component 502 of a Building 802 as shown in FIG. 8. Each ellipse placed vertically above and below the first ellipse 502 each represents an individual floor 806a-g of a building 802 as shown in FIG. 8. A first ellipse 502 is added to the chart 400 with precise dimensions such that its circumference touches at least three distinct candlesticks 401 d, g, j where price has found support and at least three distinct candlesticks where price has found resistance. Resistance is found when a price pulls back from a local peak high price value within any given ellipse, floor, building, and the like. The greater the actual number of candlestick highs, lows, opens or closes that ellipse 502 touches, the more accurate the invention will be in determining support and resistance in the future. In the example shown to illustrate the invention, the circumference of the ellipse 502 touches sixteen such candlesticks. Here, accuracy of the price prediction refers to the % price difference between actual and predictive levels. The greater the accuracy, the smaller the price difference between observed support and resistance levels and the levels derived by the price prediction.

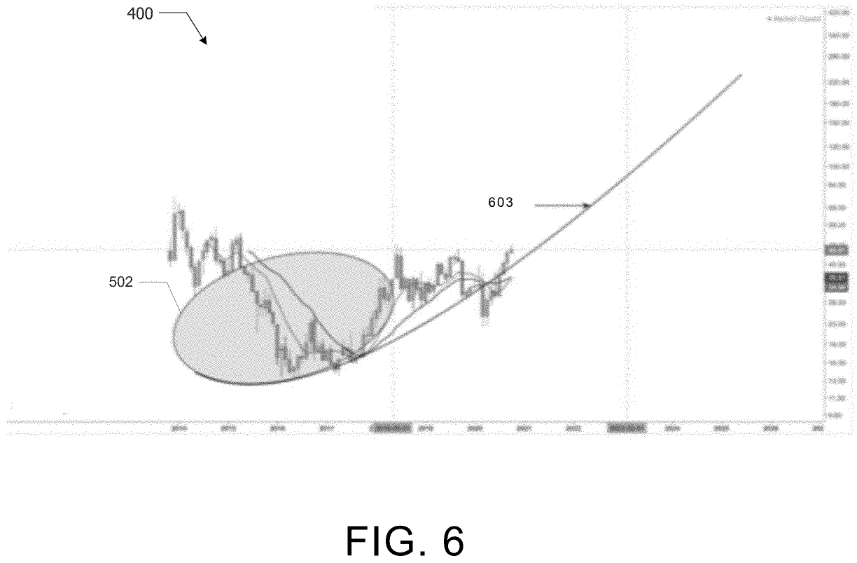

FIG. 6 is a screenshot of the same public company price chart 400 showing placement of the first elliptical component of the Price Superhighway. The Price Superhighway represents a sequence of ellipses, buildings, cities, etc. that may be constructed as stock price is analyzed and charted according to the present invention. The Price Superhighway shares properties with the ellipse 502. The curves that make up the Price Superhighway are always parabolic curves. FIG. 6 shows the first parabolic curve 603 on the chart 400 and it begins by following the circumference of ellipse 502 and extends across the chart 400 in such a way as to touch as many candlestick 401a-n highs, lows, opens or closes as possible. At a minimum, the parabolic curve 603 should touch at least three such candlesticks. The greater the actual number of candlesticks 401a-n the parabolic curve 603 touches, the more accurate the Price Superhighway in determining support and resistance. In the example shown in FIG. 6, parabolic curve 603 touches ten distinct candlesticks 601a j.

The next step in the process of the invention in constructing the Price Superhighway is the adding of parabolic curves 704 parallel to the original parabolic curve 603 and placed equally spaced apart in the vertical dimension. The first of the curves 704 is added such that it shares the same starting point (position on the horizontal or time axis) as the parabolic curve 603, but placed at a distance above 603 such that it touches at least three distinct candlestick highs, lows, opens or closes 701a-c. In the example shown, the curve 704 touches twelve distinct candlesticks 701a-1. The greater the actual number of candlesticks the parabolic curve touches, the more accurate the Price Superhighway is in determining support and resistance. Once the parabolic curve 704a is placed above the parabolic curve 603, the distance between them is preserved and matched exactly with each new parabolic curve added to the chart. The total number of parabolic curves 704a-g placed is such that the highest parabolic curve 705 reaches or exceeds the highest candlesticks in the chart. In the example shown, the number of parabolic curves on the chart is seven 704a-g, including parabolic curves 603 and 705 themselves. Collectively, the curves 603, 704a-g, and 705 define the Price Superhighway, and each individual parabolic curve 603, 704a-g, and 705 gives the precise support and resistance price levels for each monthly period.

Each point on the curve that defines the Price Superhighway of the present invention is a two-dimensional coordinate (cartesian coordinate): a specific time and a specific price value. Each of these points is therefore a forecast of a specific price level at a given moment in time. The Price Superhighway represents a forecast because the curve is already defined that may extend into the future. The various structures of the Price Superhighway; i.e., floor; building; city may be used to define and predict future price support and resistances. For example, if in a given period the current price is below the curve, then the curve will act as resistance. Recall resistance here means that price will not readily be able to cross above this value. If in a given period the current price is below the curve, then the curve will act as resistance. Recall support here means price will not readily cross below this value. These predictions of support and resistance may be found in any of the structures of the Price Superhighway.

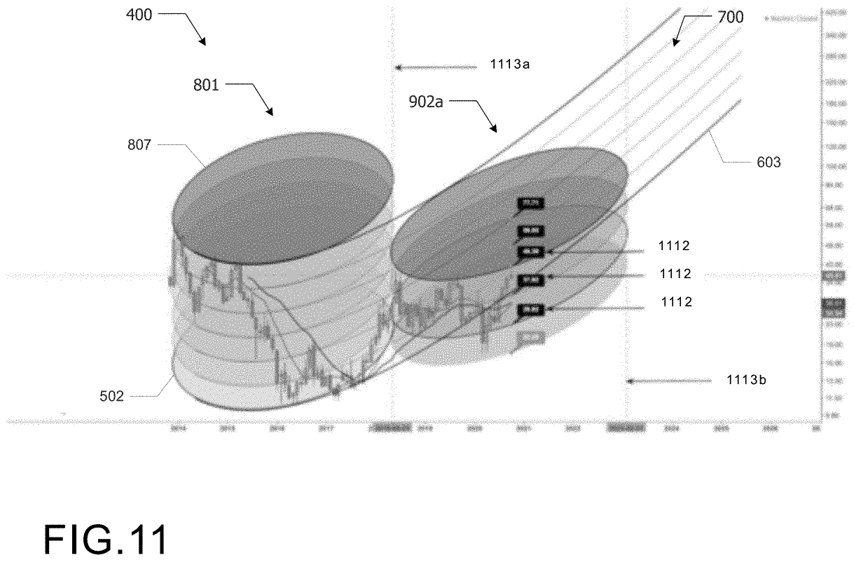

As time progresses along the horizontal axis, a price support and resistance level is given by each of the parabolic curves. Levels for the month of October 2020 are shown by the price labels 1112 in FIG. 11. If the current price of the financial instrument is above a particular parabolic curve 603, 704a-g, and 705, then that parabolic curve and all parabolic curves below it define price supports. Similarly, where the current price is below a parabolic curve, then that parabolic curve and all parabolic curves above it define price resistances. The structures of the Price Superhighway including ellipses, curves, buildings, cities and the like may all be generated by a computer processing the price charts 400. An ellipse 502 having a number of highs and lows of individual candles may be generated and then stacked to form a building. Multiple buildings may be similarly combined into a city, and so forth. Collectively and individually, the parabolic curves in the Price Superhighway 700 at times define price support, and at other times, resistance, depending on the relative position of price to each of them at each moment in time.

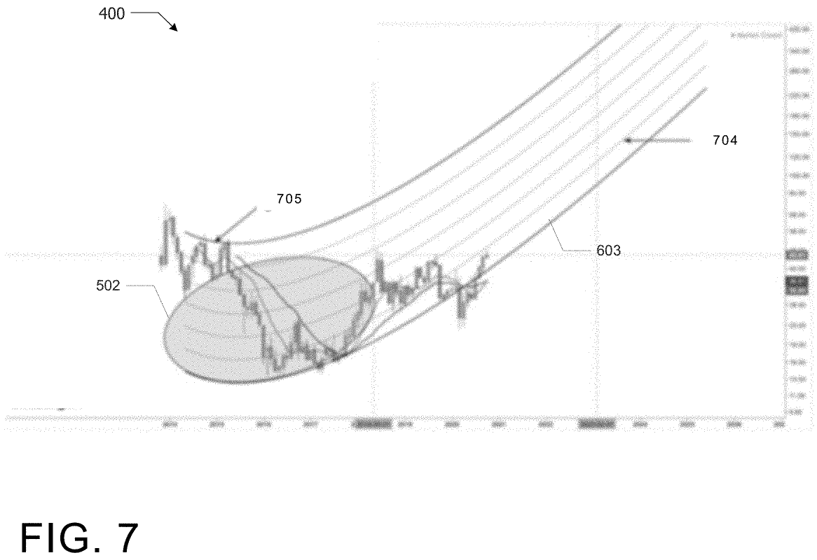

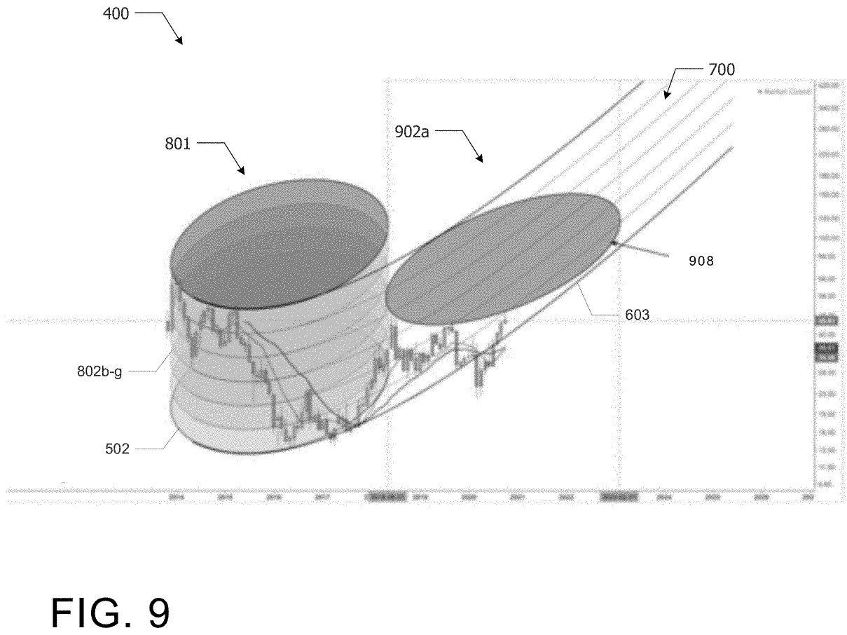

FIG. 7 is a screenshot of the same public company price chart 400 showing the complete Price Superhighway 700. FIG. 9 is a screenshot of the same public company price chart 400 showing a complete Building 801. The next step in the process of the invention is constructing the Buildings by stacking the ellipses. The Buildings sit across the Price Superhighway 700.

FIG. 8 shows the Building is constructed by adding a series of ellipses 806a-g with identical dimensions to the first ellipse 502. All the ellipses 806a-g in a Building span the same duration of time, meaning they occupy the same horizontal space or time on the chart 400. The ellipses 806a-g are placed equal distance from one another in the vertical dimension, and each ellipse sits on a parabolic curve 704a-g that defines the Price Superhighway 700. The equal vertical space between any adjacent pair of ellipses is called a Floor 802 and defines the price range of the Floor. All Floors 802a-g in the same Building 801 have the same height or price range. The span of the Building 801 marks a cycle in time. In the example shown, the previous cycle ended in May 2018 and the current cycle ends in February 2023 1113.

The highest ellipse 807, identical to the others in the Building 801, is placed so that it sits above all candlesticks completely. This ellipse is denominated the Roof 807 of the Building 801 and is denoted with a different shading or color. The colors are used as visual aids to manual traders. A program that automates all trades would dearly not need these visual color cues. The significance of the “roof” is maintained whether it is colored or not,

Similarly, colors applied elsewhere are only for visual cues to manual traders. The circumference of the roof 807, which is defined by ellipse 802g defines an important layer of price resistance above which the financial instrument is said to breakout. Breakouts above a Building 801 are more significant than those breakouts where price crosses adjacent Floors 802a-g inside a Building 801. The Building 801 shown in FIG. 8 does not show future support and resistance, but shows that, historically, price reacted to the supports and resistance levels defined either by the Floors 802a-g, the Roof 807, or the Price Superhighway 700 itself 14. This can be seen by the number of candlesticks 401a-n which have opens, closes, highs or lows on any of the parabolic curves 704a-g, 705 or ellipses 802a-g which make up the price predictions.

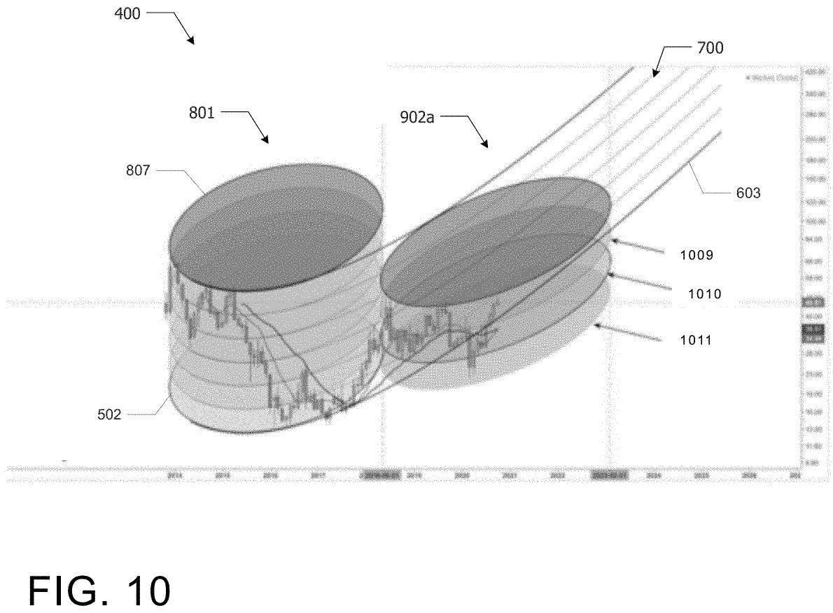

FIG. 9 is a screenshot of the same public company price chart 400 showing the first elliptical component 908 of a second Building 902a. FIG. 10 is a screenshot of the same Twitter Inc. price chart showing the second completed Building 902a on the same Price Superhighway 700. In order to show current and future support and resistance, additional Buildings (not shown) are added to the chart 400. Each new Building 902a-k placed on the Price Superhighway 700 is constructed in an identical manner, and described using FIG. 9, FIG. 10 and FIG. 11.

The first ellipse 908 is added to the chart 400 in such a way that its circumference connects at least three previous candlestick highs 401a-n. If, as in the example disclosed herein, the ellipse 908 sits above and connects the highest candlesticks in this period of the chart, the ellipse becomes the Roof 807 of this Building 902a, and is shaded the first pattern or color, i.e., red. The next stage in the construction of this Building 902a is to add parallel and equally spaced ellipses to form Floors above and below ellipse 908. In the example shown, ellipses are added to form Floors below ellipse 908 only, but they can be added above ellipse 908 to show resistance levels and Floors following a breakout above the Roof 807 of the Building 902a.

A Floor is constructed by adding a second ellipse 1009 parallel to the first ellipse 908 and is defined as a space between the stacked ellipses. Ellipse 1009 is placed such that its circumference touches the greatest number of candlestick highs, lows, opens or closes. In the example shown, the circumference of ellipse 1009 touches twelve such candlesticks. The vertical space between ellipse 908 and ellipse 1009 is denoted a Floor. The height of the Floor 802 in the Building 902a is preserved, and all additional Floors 802b-g added below ellipse 1009 maintain the same vertical height or price range. In the example shown, the Building comprises two Floors constructed using three identical ellipses. Once the height of a Floor 802 in the Building 902a is determined as described, additional Floors 802a-g above the Roof 807 can be added, each preserving the same height as the Floors 802a-g below the Roof 807. This allows a trader to detect, to forecast the potential move, and to trade more significant breakouts in price where price breaks out above all prior Floors 802a-g in the Building 902a. And in a similar way, price breaking down below all Floors 802a-g can also be detected, forecasted, and traded. In the example shown, 1010 shows the crash in February 2020 as price fell below both Floors 802a-g of the Building 902a and into a new Floor 802a-g below 1011.

FIG. 11 is a screenshot of the same public company price chart 400 showing the price support and resistance levels in the second Building 902a. It also shows the cycle duration governed by the second Building 902a. Once the Price Superhighway 700 and its buildings 902a-k has been constructed as detailed above, the precise support and resistance levels of any month can be shown on the chart 400 by labelling the price on each of the components of the Building 902i and the Price Superhighway 700 corresponding with that month. FIG. 11 shows the price labels 1112 for the month of October 2020. Note the Price Superhighway 700 shows resistance at the Roof 807 of the Building 902a to be $49.39 during the month of October 2020 and the current monthly high in price, up to the market close on the 16 Oct. 2020, is $48.25. This difference in price gives a margin of error of the Price Superhighway 700 versus the actual monthly high so far of 0.29%. The example does not exclude the possibility that prices gain in the remaining days of October and reach or exceed the resistance level of $48.25 shown. The example does however illustrate that price found resistance at ellipse 908.

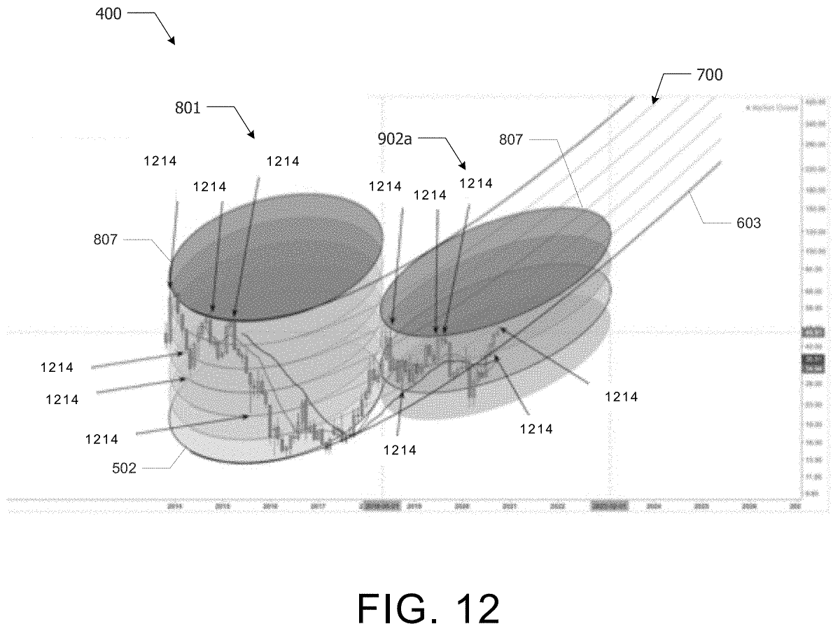

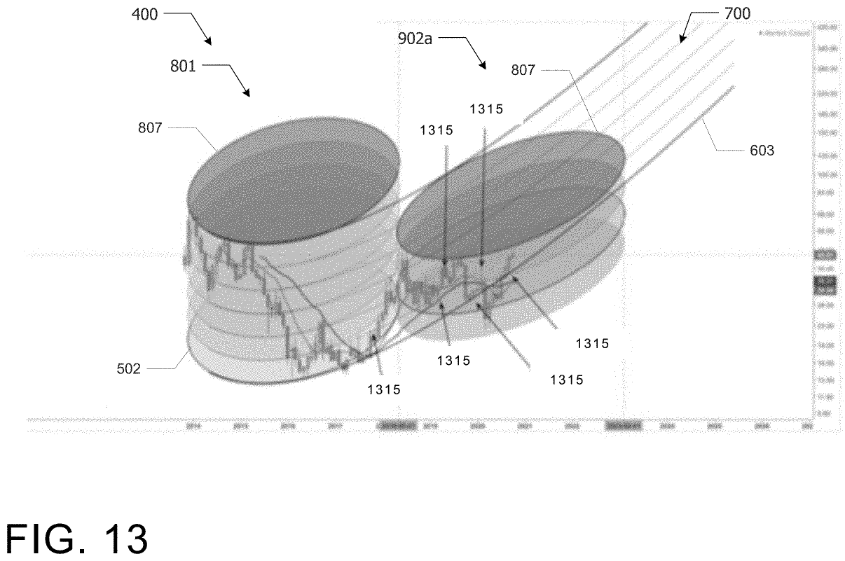

FIG. 12 is a screenshot of the same public company price chart 400 showing the multiple instances where, either the open, close, high or low of a monthly candle coincides with levels predicted by support and resistance levels defined inside a Building 902a. Over the time period shown in the chart, a majority of candlestick highs, lows, opens and closes coincide with supports and resistances defined by the price predictions. FIG. 12 shows multiple instances of price 1214 reacting to supports and resistances defined by Floors 802a-g in the Building 902a, including the resistance at the Roof 807 in October 2020.

FIG. 13 is a screenshot of the same public company price chart 400 showing the multiple instances where, either the open, close, high or low of a monthly candle coincides with levels predicted by support and resistance levels defined on the Price Superhighway 700. FIG. 13 shows multiple instances of price 1315 reacting to supports and resistances defined by the parabolic curves 704a-g, 705 that make up the Price Superhighway 700 itself.

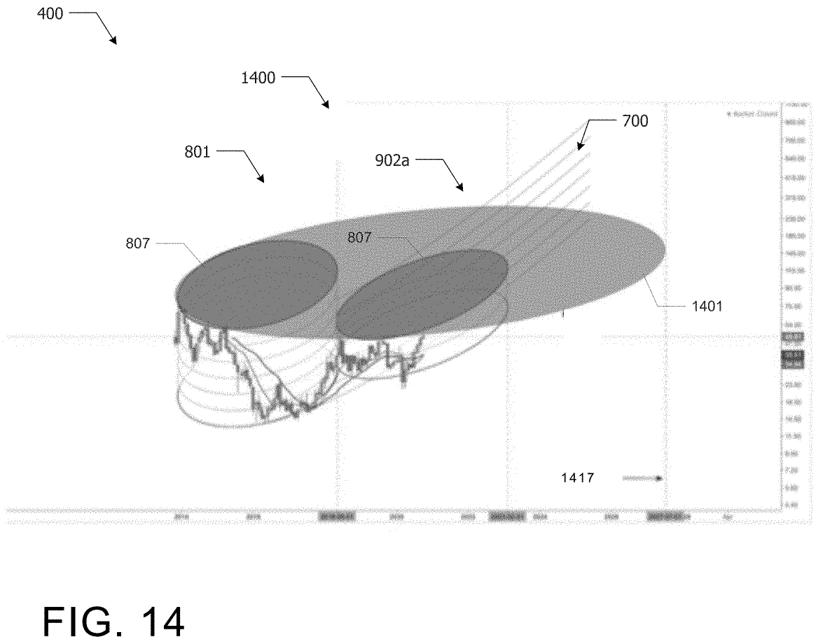

FIG. 14 is a screenshot of the same public company price chart 400 showing placement of the first elliptical component of a City 1400. A city is the next structure in the hierarchy of the Price Superhighway that begins with parabolic curves and ellipses as described above, space between two ellipses is a floor, a set of stacked floors is a building, and a city represents a larger set of stacked ellipses that span multiple buildings.

In FIG. 14, the first ellipse 1401 that forms the City 1400 is added to the chart 400 with precise dimensions such that its circumference touches at least three distinct candlestick 401a-n highs, lows, opens or closes from each of at least two different Buildings 801, 902a-m. The greater the actual number of candlesticks 401a-n highs, lows, opens or closes that ellipse 1401 touches, the more accurate the support and resistance defined by the City 1400. In the example shown to illustrate the City 1400 in FIG. 14, the circumference of the ellipse 1401 touches eleven such candlesticks 401a-n. If, as in the example used in this embodiment, the first ellipse 1401 sits above and connects the highest candlesticks 401a-n of the Buildings 801, 902a-k, the ellipse is denoted the Roof 807 of the City 1400 and shaded the first pattern or color, i.e., red. The next stage in the construction of the City is to add parallel and equally spaced ellipses to form Floors above and below ellipse 1401. In the example shown, ellipses are added to form three Floors 1518a-c below the Roof 807 of the City 1400, and one Floor 1519 above the Roof 807 of the City 1400. As with Floors 802a-g in the Buildings 902a-k, each Floor 1518-a-c, 1519 defines a set of support and resistance levels for each monthly period. And, just as with the process of constructing Floors 802a-n in the Buildings 902a-k, the first ellipse 1518a is placed such that its circumference touches the greatest number of candlesticks 401a-n highs, lows, opens or closes. In the example shown, the circumference of ellipse 1518a touches twelve such candlesticks 401a-n. The height of the Floor 802a-g, which is the distance between ellipses 1401 and 1518 is fixed and preserved for all current and future Floors 802a-g in the City 1400.

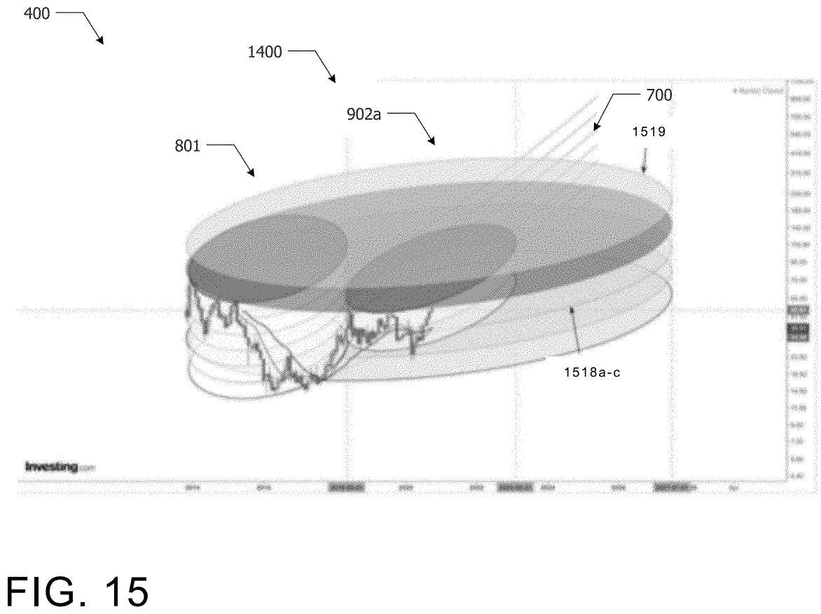

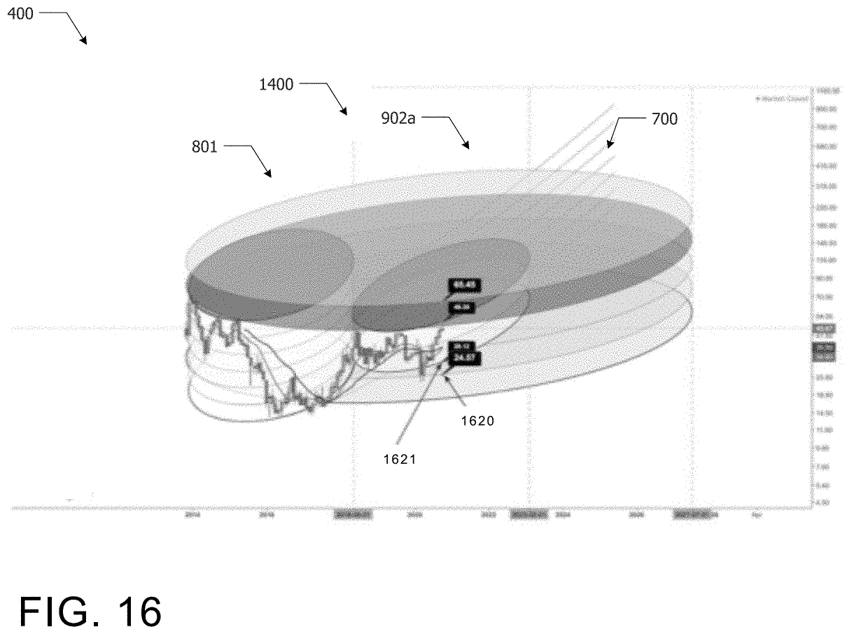

FIG. 15 is a screenshot of the same public company price chart 400 showing a complete City 1400. FIG. 16 is a screenshot of the same public company price chart 400 marking support and resistance levels defined by a Building 902a-k together with support and resistance levels defined by the City 1400. The candlestick chart 400 comprising the Buildings 902a-k and the City 1400 now shows different hierarchical levels of support and resistance associated with long term and short-term cycles. In FIG. 16, the price level labeled 1621 defines a support level given by the short-term cycle of the Building 902a for the month of October 2020. The price level labeled 1620 defines a support level given by the longer-term cycle or super cycle given by the City 1400 for the month of October 2020.

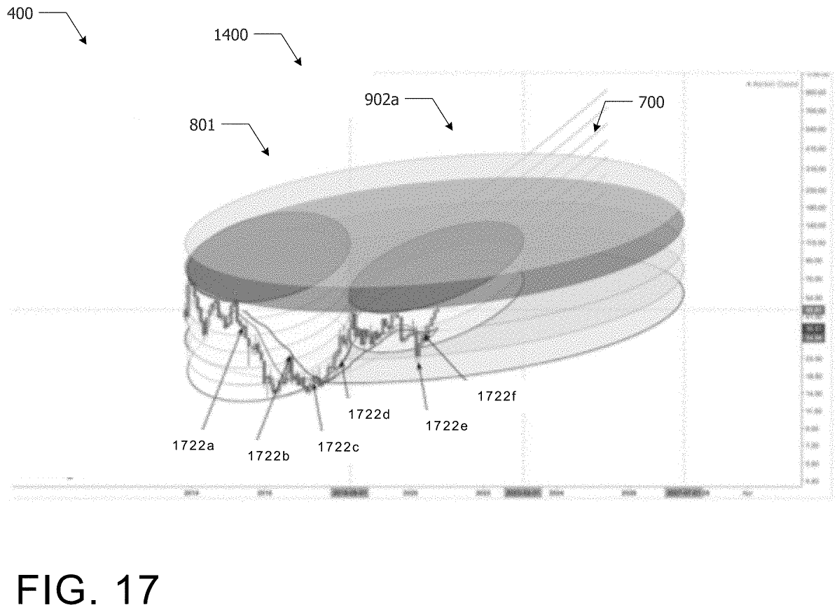

FIG. 17 is a screenshot of the same public company price chart 400 showing the multiple instances where, either the open, close, high or low of a monthly candle 401a-n coincides with levels predicted by support and resistance levels defined by the City 1400. Over the time period shown in the chart 400, a majority of candlestick 401a-n highs, lows, opens and closes which did not coincide with supports and resistances defined by either the Buildings 902a-n or the Price Superhighway 700 are shown to react to levels shown by the higher order support and resistance levels defined by the City 1400. FIG. 17 shows six such instances 1722a-f.

In sum, the current short-term cycle defined by the Building 902a ends February 2023 1113b, and the super cycle defined by the City 1400 ends July 2027 1417. As was the case with cycles, the significance of the end of a super cycle is that price is forecast to experience a significant change in character. This could mean a price crash, a significant breakout or a trend change.

The process prescribed thus far shows the construction of Building 902a-k and Cities 1400. The methodology pertaining to this Price Superhighway 700 is however, not constrained by the number of layers of support and resistance that can be added to the candlestick chart 400. This means that an additional hierarchical layer of support and resistance could be further added to the chart, one which encompasses two or more Cities 1400. This process of adding new layers in the hierarchy at any time distinguishes this methodology from others that have preceded it. It allows the trader, or computerized trading system based on it, to be able to forecast support and resistance levels long into the future.

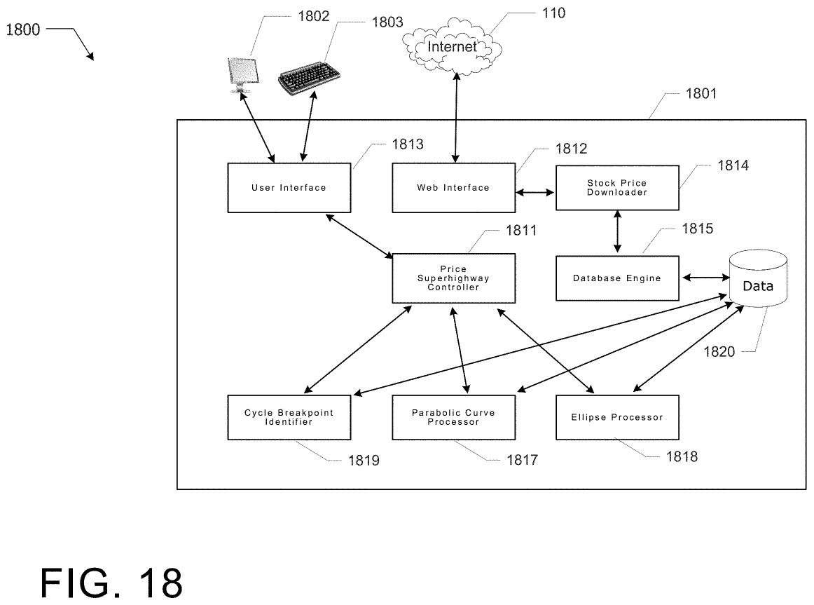

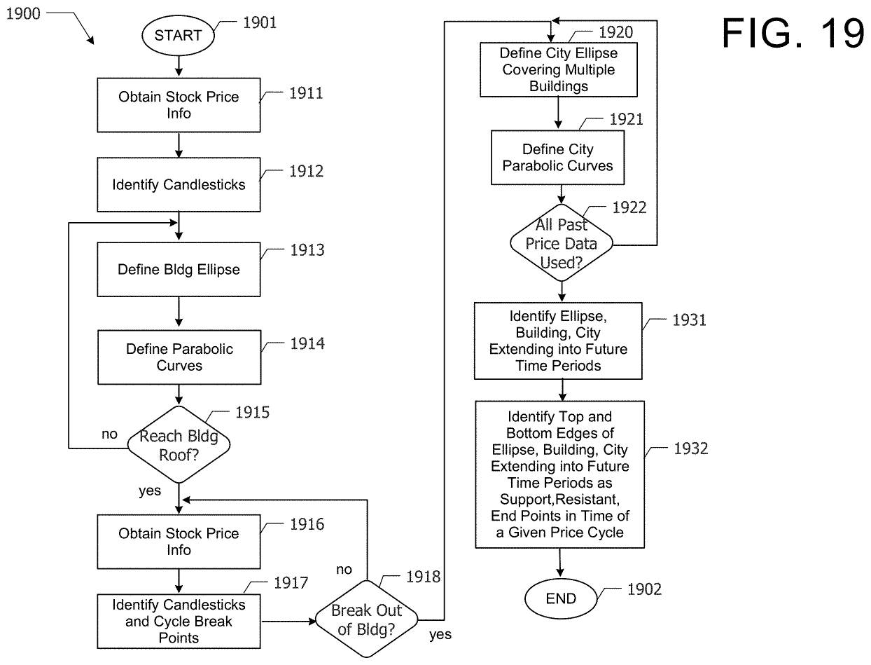

FIG. 18 illustrates a set of software components running on one or more computers to implement the calculation of support and resistance levels defined on the Price Superhighway according to the present invention. The set of software components 1800 comprises a price superhighway controller 1811, a web interface 1812, a user interface 1813, a stock price downloader 1814, a database engine 1815 coupled to local data storage 1820, a parabolic curve processor 1817, an ellipse structure processor 1818, and a cycle, support, and resistance identifier 1817. These components may be hosted on a broker computing system 120, a web server 105, or some combination of the two processing systems.

The price superhighway controller 1811 is an overall controller of all of the set of software components that receives commands from a user to obtain stock price data for a particular traded stock and initiates a sequence of actions taken by the remaining set of software components to download stock price data, store the stock price data into the database 1820, and initiate processing of the stock price data in the database 1820 to create one or more structures within a Price Superhighway. The price superhighway controller 1811 sequences and coordinates the data processing of the stock price data from the database 1820 to provide a Price Superhighway representation of the data over a time period specified by the user.

The web interface 1812 permits the computing system hosting set of software components 1800 to communicate with remote user computing devices 130, 105 and mobile devices 131. The web interface 1812 performs all of the data formatting, computer to computer communications, encryption processing, and all similar operations needed by the computing system hosting the set of software components 1800 to communicate with users.

The user interface 1813 provides input and output processing to provide a broker or user with messages and data needed to perform the Price Superhighway data processing and analysis functions. This interface module 1813 also accepts commands from the driver to instruct the application to perform these tasks.

The stock price downloader 1814 obtains stock price data for a selected traded stock from a remote stock price data source (not shown). The stock price downloader 1814 may obtain past stock price data for any specified time period defined by a user. The stock price downloader 1814 also may obtain current stock prices for the specified traded stock while a market is open, and trading of the stock is active. These prices are stored within the database 1820 for use by other software components.

The database engine 1815 processes all database operations for the Price Superhighway. These operations include insertion of stock price candles, ellipses, buildings, and cities into the database 1820, deletion of estock price candles, ellipses, buildings, and cities from the database 1820, searching and retrieving stock price candles, ellipses, buildings, and cities from the database 1820, and indexing the database 1820 to maintain efficient searching when needed.

The parabolic curve processor 1818 generates a Price Superhighway from a time series of stock price values obtained from the database 1920. The parabolic curve processor 1818 obtains the price data in the form of candles of high and low values for a trading period and calculates a set of parabolic curves about an analysis starting point in time. A set of parabolic curves are generated from an initial ellipse that matches a maximum number of high and low endpoints of these candles over a period of time. The parabolic curve data is subsequently used by the ellipse structure processor 1819 to create one or more hierarchical structures of the Price Superhighway.

The ellipse structure processor 1819 starts with the initial ellipse and set of parabolic curves from parabolic curve processor 1818 to create a series of stacked ellipses that define floors to a building structure. The ellipse structure processor 1819 repeats the process using additional historical price candles to construct multiple buildings and an overarching ellipse of a city as the entire Price Superhighway is constructed from the historical stock price data.

The cycle, support, and resistance identifier 1817 identifies Price Superhighway structures created by the ellipse structure processor 1819 using historical stock price data that extend into the future. These structures may be used to predict price support levels, price resistance levels, and price cycle end points in time from the portions of these structures that are extending into the future.

FIG. 19 illustrates a flowchart corresponding to a method performed by a software components system for creating a hierarchical system of trading signals in financial markets according to the present invention. according to the present invention. The process 1900 begins at step 1901 with the obtaining of historical stock price data in step 1911. Step 1912 identifies candlesticks of price data that represent a trading range of the traded stock over a trading time period. The candlesticks are defined by the high and low traded price for the particular stock during the corresponding trading time period.

Step 1913 determines an initial ellipse that touches a maximum number of candle end points over a time period about a starting point in time. From the initial ellipse, step 1914 generates a set of parabolic curves corresponding to the range of prices in the initial ellipse. A set of ellipses are placed along these parabolic curves in a vertical fashion to define floors between the set of ellipses of a building all having a common time period. Test step 1915 determines if a roof of this building has been reached by the stacking of the ellipses along the set of parabolic curves, and if not, the process 1900 returns to step 1913 to generate the next ellipse and floor of the building.

When test step 1915 determines that a roof has been reached by an ellipse that matches or exceeds a local high candle value, the process 1900 continues to step 1916 to begin processing stock price candle data values outside of a time period defined by the building. Step 1917 processes additional stock price candles to identify cycle time period ends as defined by the time range of a current building and test step 1918 determines whether the price has broken out of the building or if the time of the cycle has ended, and if not, the process returns to step 1916 continue the processing until a breakout or cycle end occurs.

When test step 1918 determines that a cycle has ended, the process 1900 proceeds to step 1920 to generate a city ellipse that encompasses multiple adjacent buildings within the Price Superhighway. The parabolic curves associated with the city ellipse is generated for the city in step 1921 and test step 1922 determines whether all of the available stock price candlestick data has been used, and if not the process 1900 returns to step 1921 to continue the processing. When test step 1922 determines that all of the historical stock price data has been included into the Price Superhighway, step 1931 identifies one or more of the Price Superhighway structures' ellipses extends into the future. Step 1932 identifies price support and resistance levels from these identified Price Superhighway structures' ellipse as well as an end of a price cycle when the ellipses reach an end point in time. With the price support and resistance levels and the price cycle end points identified, the process 1990 ends 1902.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, and transfer of content(s) or data between any combination of the components.

What is claimed is:

1. A broker computing device for creating a hierarchical system of trading signals in financial markets, the broker computing device being communicatively connected to one or more stock market computing devices over the Internet, the one or more stock market computing devices provide securities price data on securities available to initiate trades using the one or more stock market computing devices, the broker computing device comprising:
a memory having instructions stored thereon; and
a processor configured to execute the instructions on the memory to cause the broker computing device to:
obtain securities price data for a requested period of time, the securities price data comprises an opening price, a closing price, a highest price, and a lowest price for a particular security during a specified trading time period;
identify security price candlesticks for each of the specified trading periods within the requested period of time, the candlesticks for each specified trading period comprises a range of securities price values between the highest price and the lowest price in each of the specified trading periods as plotted on a price chart;
define a building ellipse having an edge found within a maximum number of candlesticks within the request time period of candlestick data, the building ellipse having an ellipse starting location on the price chart defined by the lowest price for the first candlestick used to define the building ellipse and the time value corresponding to the first candlestick used to define the building ellipse;
define a set of parabolic curves, a first parabolic curve of the set of parabolic curves having a starting point identical to the ellipse starting location and a second parabolic curve within the set of parabolic curves being parallel to the first parabolic curve and located at a floor distance above the first parabolic curve such that the second parabolic curve possesses at least three data values within candlesticks in contact with the building ellipse, and each additional parabolic curves within the set of parabolic curves absent the first and second parabolic curves are located a floor distance above a prior parabolic curve within the set of parabolic curves until a highest parabolic curve is a last parabolic curve having a value within a highest candlestick within one or more candlesticks within the building ellipse;
identify at least one ellipse having a time value beyond the time value of the latest candlestick in the requested time period; and
identify top and bottom edges of the at least one building ellipse on the price chart having a time value beyond the time value of the latest candlestick in the requested time period as support and resistance values for the securities price data and a latest time value of the ellipse, the latest time value of the at least one building ellipse on the price chart defines an end of a price value cycle.

2. The broker computing device according to claim 1, wherein the processor configured to execute additional instructions to further cause the broker computing device to:
obtain additional securities price data for a second requested period of time;
identify additional security price candlesticks for each of the specified trading periods within the second requested period of time,
when the additional security price candlesticks have time values beyond the range of the building ellipse, the additional instructions to further cause the broker computing device to:
define a second building ellipse having an edge found having at least three candlesticks in which each of the at least three candle sticks highest price on the second ellipse;
define a second set of parabolic curves, a first parabolic curve of the second set of parabolic curves having a starting point identical to the second ellipse starting location and a second parabolic curve within the second set of parabolic curves being parallel to the first parabolic curve of the second set of parabolic curves, and located at a second floor distance above the first parabolic curve of the second set of parabolic curves such that the second parabolic curve of the second set of parabolic curves possesses at least three data values within additional candlesticks in contact with the second building ellipse, and each additional parabolic curves within the second set of parabolic curves absent the first and second parabolic curves are located the second floor distance above a prior parabolic curve within the second set of parabolic curves until a highest parabolic curve is a last parabolic curve having a value within a highest candlestick within one or more candlesticks within the second building ellipse;
identify at least one building ellipse having a time value beyond the time value of the latest candlestick in the requested time period; and
identify top and bottom edges of the at least one second building ellipse on the price chart having a time value beyond the time value of the latest candlestick in the second requested time period as support and resistance values for the securities price data and a latest time value of the second building ellipse, the latest time value of the at least one second building ellipse on the price chart defines an end of a second price value cycle.

3. The broker computing device according to claim 2, wherein the processor configured to execute additional instructions to further cause the broker computing device to:
define a city ellipse having an edge found having at least three candlesticks in which each of the at least three candlesticks highest price on the second ellipse;
define a set of city parabolic curves, a first city parabolic curve of the set of city parabolic curves having a starting point identical to the city ellipse starting location and a city parabolic curve within the set of city parabolic curves being parallel to the first city parabolic curve of the set of city parabolic curves, and located at a city floor distance above the first city parabolic curve of the set of city parabolic curves such that the second city parabolic curve of the set of city parabolic curves possesses at least three data values within additional candlesticks in contact with the city ellipse, and each additional city parabolic curves within the set of city parabolic curves absent the first and second city parabolic curves are located the city floor distance above a prior city parabolic curve within the set of city parabolic curves until a highest city parabolic curve is a last city parabolic curve having a value within a highest candlestick within one or more candlesticks within the city ellipse;
identify at least one city ellipse having a time value beyond the time value of the latest candlestick in the additional requested time period; and
identify top and bottom edges of the at least one city ellipse on the price chart having a time value beyond the time value of the latest candlestick in the additional requested time period as support and resistance values for the securities price data and a latest time value of the second ellipse, the latest time value of the at least one second ellipse on the price chart defines an end of a city price value cycle.

4. The broker computing device according to claim 1, wherein the broker computing device further comprises:
a local data storage device; and
a database engine for storing, organizing, searching, and displaying securities price data, candlestick data, building ellipse data, sets of parabolic curves data, city ellipse data, and sets of city parabolic ellipse data.

5. The broker computing device according to claim 4, wherein broker computing device further comprises:
a user interface configured to present the price chart and its corresponding securities price data, candlestick data, building ellipse data, sets of parabolic curves data, city ellipse data, and sets of city parabolic ellipse data.

6. A method for creating a hierarchical system of trading signals in financial markets within a broker computing device, the broker computing device being communicatively connected to one or more stock market computing devices over the Internet, the one or more stock market computing devices provide securities price data on securities available to initiate trades using the one or more stock market computing devices, the method comprises:
obtaining securities price data for a requested period of time, the securities price data comprises an opening price, a closing price, a highest price, and a lowest price for a particular security during a specified trading time period;
identifying security price candlesticks for each of the specified trading periods within the requested period of time, the candlesticks for each specified trading period comprises a range of securities price values between the highest price and the lowest price in each of the specified trading periods as plotted on a price chart;
defining a building ellipse having an edge found within a maximum number of candlesticks within the request time period of candlestick data, the building ellipse having an ellipse starting location on the price chart defined by the lowest price for the first candlestick used to define the building ellipse and the time value corresponding to the first candlestick used to define the building ellipse;
defining a set of parabolic curves, a first parabolic curve of the set of parabolic curves having a starting point identical to the ellipse starting location and a second parabolic curve within the set of parabolic curves being parallel to the first parabolic curve and located at a floor distance above the first parabolic curve such that the second parabolic curve possesses at least three data values within candlesticks in contact with the building ellipse, and each additional parabolic curves within the set of parabolic curves absent the first and second parabolic curves are located a floor distance above a prior parabolic curve within the set of parabolic curves until a highest parabolic curve is a last parabolic curve having a value within a highest candlestick within one or more candlesticks within the building ellipse;
identifying at least one ellipse having a time value beyond the time value of the latest candlestick in the requested time period; and
identifying top and bottom edges of the at least one building ellipse on the price chart having a time value beyond the time value of the latest candlestick in the requested time period as support and resistance values for the securities price data and a latest time value of the ellipse, the latest time value of the at least one building ellipse on the price chart defines an end of a price value cycle.

7. The method according to claim 1, wherein method further comprises:
obtaining additional securities price data for a second requested period of time;
identifying additional security price candlesticks for each of the specified trading periods within the second requested period of time,
when the additional security price candlesticks have time values beyond the range of the building ellipse, the additional instructions to further cause the broker computing device to:
defining a second building ellipse having an edge found having at least three candlesticks in which each of the at least three candle sticks highest price on the second ellipse;
defining a second set of parabolic curves, a first parabolic curve of the second set of parabolic curves having a starting point identical to the second ellipse starting location and a second parabolic curve within the second set of parabolic curves being parallel to the first parabolic curve of the second set of parabolic curves, and located at a second floor distance above the first parabolic curve of the second set of parabolic curves such that the second parabolic curve of the second set of parabolic curves possesses at least three data values within additional candlesticks in contact with the second building ellipse, and each additional parabolic curves within the second set of parabolic curves absent the first and second parabolic curves are located the second floor distance above a prior parabolic curve within the second set of parabolic curves until a highest parabolic curve is a last parabolic curve having a value within a highest candlestick within one or more candlesticks within the second building ellipse;
identifying at least one building ellipse having a time value beyond the time value of the latest candlestick in the requested time period; and
identifying top and bottom edges of the at least one second building ellipse on the price chart having a time value beyond the time value of the latest candlestick in the second requested time period as support and resistance values for the securities price data and a latest time value of the second building ellipse, the latest time value of the at least one second building ellipse on the price chart defines an end of a second price value cycle.

8. The method according to claim 7, wherein the method further comprises:
defining a city ellipse having an edge found having at least three candlesticks in which each of the at least three candlesticks highest price on the second ellipse;
defining a set of city parabolic curves, a first city parabolic curve of the set of city parabolic curves having a starting point identical to the city ellipse starting location and a city parabolic curve within the set of city parabolic curves being parallel to the first city parabolic curve of the set of city parabolic curves, and located at a city floor distance above the first city parabolic curve of the set of city parabolic curves such that the second city parabolic curve of the set of city parabolic curves possesses at least three data values within additional candlesticks in contact with the city ellipse, and each additional city parabolic curves within the set of city parabolic curves absent the first and second city parabolic curves are located the city floor distance above a prior city parabolic curve within the set of city parabolic curves until a highest city parabolic curve is a last city parabolic curve having a value within a highest candlestick within one or more candlesticks within the city ellipse;
identifying at least one city ellipse having a time value beyond the time value of the latest candlestick in the additional requested time period; and
identifying top and bottom edges of the at least one city ellipse on the price chart having a time value beyond the time value of the latest candlestick in the additional requested time period as support and resistance values for the securities price data and a latest time value of the second ellipse, the latest time value of the at least one second ellipse on the price chart defines an end of a city price value cycle.

9. The method according to claim 8, wherein the broker computing device further comprises:
a local data storage device; and
a database engine for storing, organizing, searching, and displaying securities price data, candlestick data, building ellipse data, sets of parabolic curves data, city ellipse data, and sets of city parabolic ellipse data.

10. The method according to claim 8, wherein the broker computing device further comprises:
a user interface configured to present the price chart and its corresponding securities price data, candlestick data, building ellipse data, sets of parabolic curves data, city ellipse data, and sets of city parabolic ellipse data.
